(19) United States
(12) Patent Application Publication
(10) Pub. No.: US 2016/0138792 A1
(43) Pub. Date: May 19, 2016

(54) ENERGY-SAVING LIGHTING DEVICE WITH MULTIMEDIA AND HIGH EFFICIENCY FILTERING AND PURIFYING FUNCTIONS

(71) Applicant: XIAMEN XING HENGLONG LIGHTING TECHNOLOGY CO., LTD., Xiamen (CN)

(72) Inventor: Hongyan WANG, Xiamen (CN)

(73) Assignee: XIAMEN XING HENGLONG LIGHTING TECHNOLOGY CO., LTD., Xiamen (CN)

(21) Appl. No.: 14/637,515

(22) Filed: Mar. 4, 2015

(30) Foreign Application Priority Data
Nov. 18, 2014 (CN) 201420696622.8

(51) Int. Cl. F21V 29/60; F21V 33/00

(52) U.S. Cl. CPC F21V 29/60; F21V 33/0052; F21V 33/0096; F21Y 2101/02

(57) ABSTRACT

An energy-saving lighting device with multimedia and high efficiency filtering and purifying functions includes a housing, a centrifugal fan, an HEPA filter, an LED light source panel, a controller and a power device. The LED light source panel is attached to the front side of the housing; the housing is disposed with an air inlet and an air outlet, an airway is disposed between the air inlet and the air outlet and the air way goes through the rear side of the LED light source panel, the centrifugal fan is disposed in the airway; the HEPA filter is assembled in the airway and is placed between the air inlet of the housing and the centrifugal fan; the output of the controller is respectively connected to the centrifugal fan and the LED light source panel; the power device is connected to the controller.

### FIELD OF THE INVENTION

The present invention relates to LED technology, especially to an energy-saving lighting device with multimedia and high efficiency filtering and purifying functions.

### BACKGROUND OF THE INVENTION

Lighting devices are daily living apparatus, traditional lighting devices are applied with tungsten filament as the light source, but it has low light efficiency, short service life and other disadvantages. LED, light-emitting diode, is made of electroluminescence semiconductor material, it has low voltage, high efficiency, well monchromaticity, strong applicability, well stability, short response time, long service life, pollution-free and other advantages; LED is usually powered by low voltage power, the supply voltage gets 2-24V, so that it is safe; LED assumes less energy than the same light efficiency filament lamp, about 80%; each unit of LED has small size, so that it can make many kinds of lighting devices that are suitable to different environment. With above good performances, LED light sources are widely used in indicating, displaying, decorating, backlighting, traditional lighting fields. There are many kinds of LED energy-saving lighting devices, but these LED energy-saving lighting devices can not filter and purify the air, besides, they are applied with LED as the light source, when LED works, it generates lots of heat, so that it has to consider the heat dissipation of the LED light source panel.

### SUMMARY OF THE INVENTION

The object of the present invention is to solve the disadvantages of the existing known technology and to provide with an energy-saving lighting device with multimedia and high efficiency filtering and purifying functions, on one hand, it can filter and purify the air, on another hand, it can efficiently solve the heat dissipation of the LED light source panel, thus prolonging service life, it can also realize multimedia function.

The technical proposal of the present invention to solve the technical problems is that: an energy-saving lighting device with multimedia and high efficiency filtering and purifying functions, comprising a housing, a centrifugal fan, an HEPA filter, an LED light source panel, a controller and a power device; the LED light source panel is attached to the front side of the housing; the housing is disposed with an air inlet and an air outlet, an airway is disposed between the air inlet and the air outlet and the air way goes through the rear side of the LED light source panel, the centrifugal fan is disposed in the airway; the HEPA filter is assembled in the airway and is placed between the air inlet of the housing and the centrifugal fan; the output of the controller is respectively connected to the centrifugal fan and the LED light source panel; the power device is connected to the controller.

In another preferred embodiment, the air inlet of the housing is disposed at the center of the front side of the housing, the LED light source panel encircles at the periphery of the air inlet; the centrifugal fan is assembled at the center of the inner side of the rear side of the housing, the inlet of the centrifugal fan is opposite to the air inlet of the housing, the HEPA filter is assembled between the air inlet of the housing and the inlet of the centrifugal fan.

In another preferred embodiment, the air outlet of the housing is disposed at the periphery of the side surface of the housing and is connected to the outlet of the centrifugal fan, so that the airway goes through the rear side of the LED light source panel.

In another preferred embodiment, the side surface of the housing is inclinedly disposed, the size of the periphery of the front side is smaller than that of the rear side.

In another preferred embodiment, the rear side of the housing is disposed with a protruding backwardly, the centrifugal fan is accommodated in the inner side of the protruding.

In another preferred embodiment, the air inlet of the housing is disposed with a cover plate, the cover plate is gridded.

In another preferred embodiment, the air outlet of the housing is disposed with gridded structure.

In another preferred embodiment, the front side of the housing is square shaped.

In another preferred embodiment, it further comprises an infrared receiver, the output of the infrared receiver is connected to the controller.

In another preferred embodiment, it further comprises a Bluetooth speaker box, the Bluetooth speaker box is connected to the power device.

The energy-saving lighting device with multimedia and high efficiency filtering and purifying functions of the present invention is applying HEPA purifying technology to the existing lighting device to filter the dust, pollen and smog of the air; it also has Bluetooth music playing function, so that it can be conveniently controlled in the handphone, computer and other devices with Bluetooth; and with the infraction remote controller, people can remote control the brightness and color of the lighting device, it is very convenient. The light device is a multimedia lighting device combining lighting, purifying, music playing, light adjusting functions. Starting the power, under the work of the centrifugal fan, air with inhalable particles enters through the air inlet of the housing, after purified by the HEPA filter, the air is hurled out of the blade of the centrifugal fan, when passing through the rear side of the hot body, the LED light source panel, the air takes the heat of the hot body out. It not only purifies air, but also cooling the lighting device, thus extending the service life of the LED efficiently. And with the infraction remote controlling function, it can control the purifying speed, brightness of the lighting device. When the Bluetooth speaker box receives the handphone's Bluetooth wireless signal, it can select and control the music and the volume.

1. the energy-saving lighting device with multimedia and high efficiency filtering and purifying functions is composited with a housing, a centrifugal fan, an HEPA filter, an LED light source panel, a controller and a power device; the LED light source panel is attached to the front side of the housing; the housing is disposed with an air inlet and an air outlet, an airway is disposed between the air inlet and the air outlet and the air way goes through the rear side of the LED light source panel, the centrifugal fan is disposed in the airway; the HEPA filter is assembled in the airway and is placed between the air inlet of the housing and the centrifugal fan; the output of the controller is respectively connected to the centrifugal fan and the LED light source panel; the power device is connected to the controller. This structure of the present invention combines air purifying and LED heat dissipation, on one hand, it can filter and purify the air, on the other hand, it can better solve the heat dissipation of the LED light source panel, thus extending the service life of the LED.

2. as the present invention is further applied with infraction receiver, the infraction receiver receives the control signal from the remote controller so as to control the rotating speed of the centrifugal fan, it can also control the brightness and color of the LED light sources, thus obtaining remote controlling the filtering and purifying speed, brightness and color, it is used conveniently.

3. as the present invention is further applied with a Bluetooth speaker box, it can realize multimedia function by applying with Bluetooth device like a handphone, so that it extends the usage scope of the energy-saving lighting device.

The present invention will be further described with the drawings and the embodiment; but the present invention of an energy-saving lighting device with multimedia and high efficiency filtering and purifying functions is not limited to the embodiment.

### BRIEF DESCRIPTION OF THE DRAWINGS

FIG. 1 illustrates a schematic diagram of the present invention.

FIG. 2 illustrates a front view diagram of the present invention.

FIG. 3 illustrates a top view diagram of the present invention.

FIG. 4 illustrates a rear view diagram of the present invention.

FIG. 5 illustrates a sectional view diagram of A-A line in FIG. 4.

FIG. 6 illustrates a circuit principle diagram of the present invention.

### DETAILED DESCRIPTION OF THE EMBODIMENT

### The Embodiment

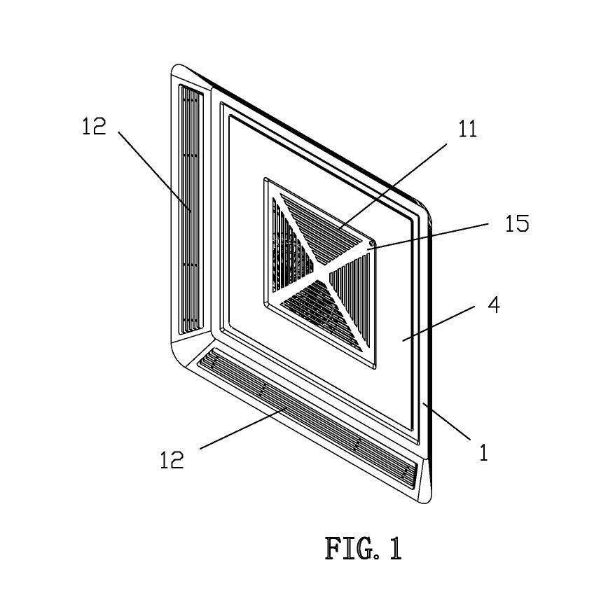

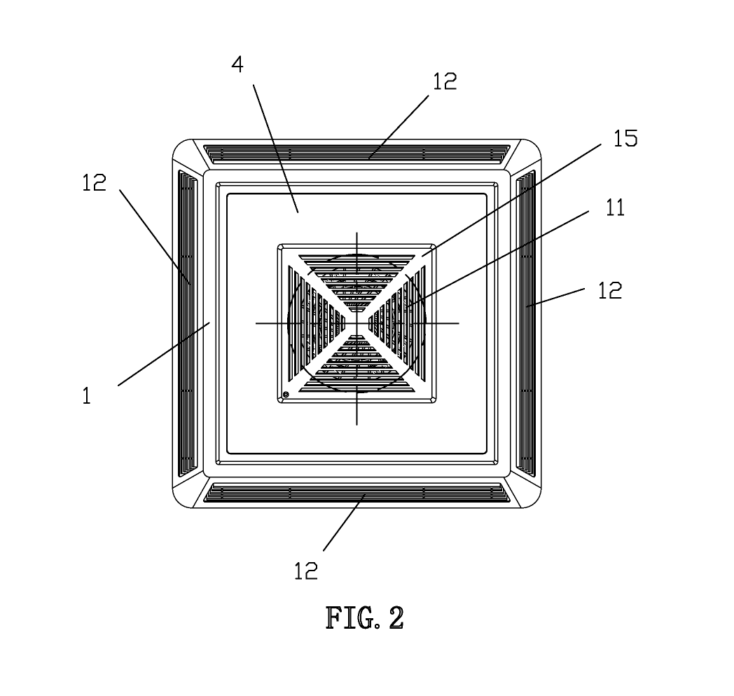

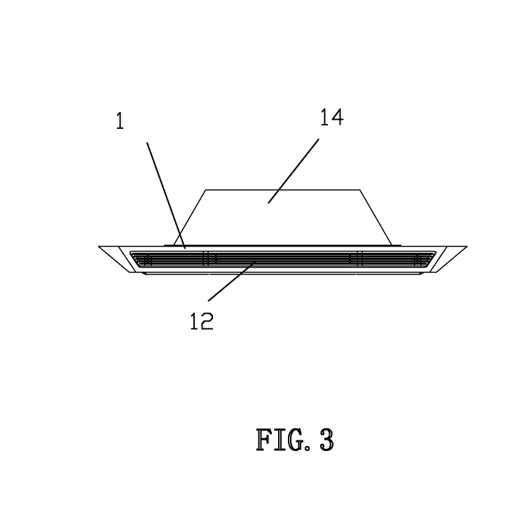

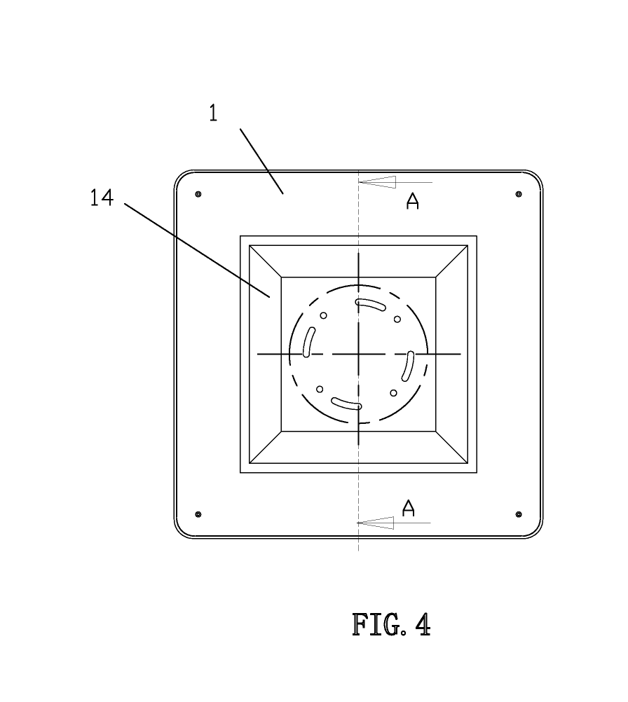

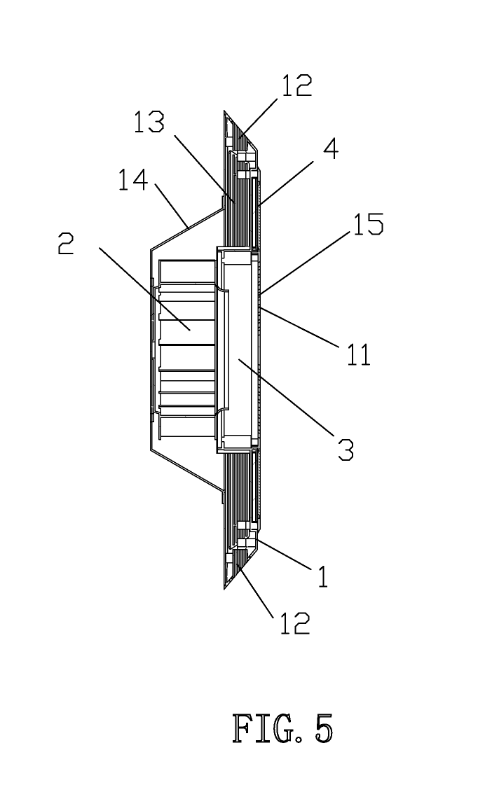

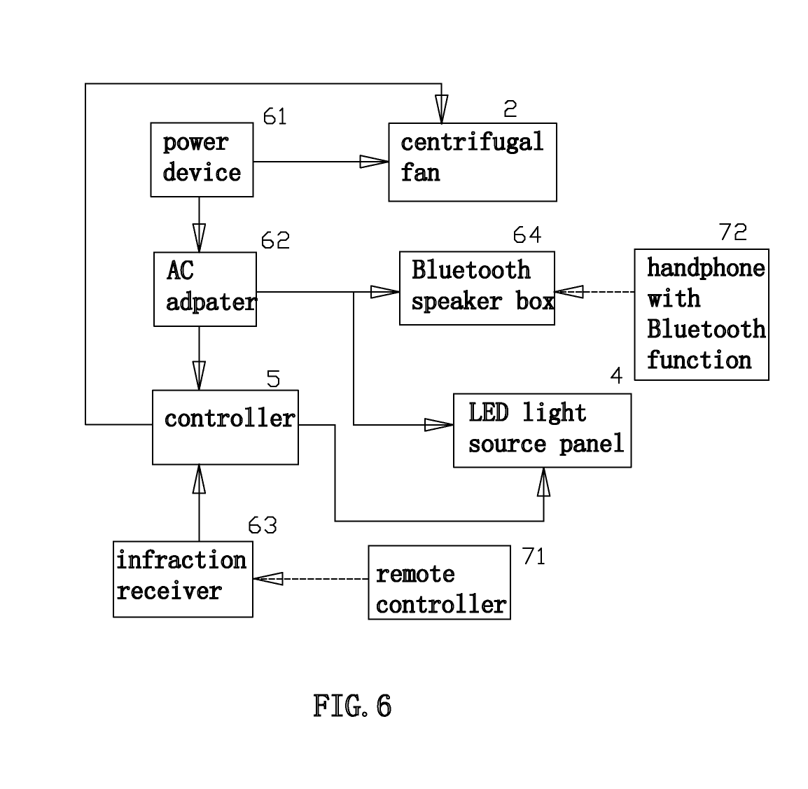

Please referring to FIGS. 1-6, an energy-saving lighting device with multimedia and high efficiency filtering and purifying functions comprises a housing 1, a centrifugal fan 2, a HEPA filter 3, a LED light source panel 4, a controller 5 and a power device; the LED light source panel 4 is assembled at the front side of the housing 1; the housing 1 is disposed with an air inlet 11 and an air outlet 12, an airway 13 is disposed between the air inlet 11 and the air outlet 12 and the airway 13 goes through the rear side of the LED light source panel, the centrifugal fan 2 is assembled in the airway 13; the HEPA filter 3 is assembled in the airway 13 and is placed between the air inlet 11 of the housing 1 and the centrifugal fan 2; the output of the controller 5 is respectively connected to the centrifugal fan 2 and the LED light source panel 4, the controller 5 controls the rotating speed of the centrifugal fan 2, the controller 5 also controls the brightness and the color of the LED light sources; the power device is connected to the controller 5. The power device can be applied with AC power 61 and AC adapter 62, the centrifugal fan 2 is applied with AC power supply, the AC power 61 directly supplies power to the centrifugal fan 2, the

AC power 61 supplies power to the controller 5 by the AC adapter 62. HEPA (High efficiency particulate air Filter) filter is a filter screen meeting the HEPA standard, garnering 99.7% of effective rate for 0.1 μm and 0.3 μm, HEPA filter has a character that air can pass through it, but small particles can't.

The air inlet 11 of the housing is disposed at the center of the front side of the housing 1, the LED light source panel 4 encircles the periphery of the air inlet 11; the centrifugal fan 2 is assembled at the center of the inner side of the rear side of the housing 1, the inlet of the centrifugal fan 2 is opposite to the air inlet of the housing 1, the HEPA filter 3 is assembled between the air inlet 11 of the housing and the inlet of the centrifugal fan 2.

The air outlet 12 of the housing is disposed at the periphery of the side surface of the housing 1 and is connected to the outlet of the centrifugal fan 2, so that the airway goes through the rear side of the LED light source panel 4.

The side surface of the housing 1 is inclinedly disposed, the size of the periphery of the front side is smaller than that of the rear side.

The rear side of the housing 1 is disposed with a protruding 14 backwardly, the centrifugal fan 2 is accommodated in the inner side of the protruding 14.

The air inlet of the housing 1 is disposed with a cover plate 15, the cover plate 15 is gridded.

The air outlet 12 of the housing is disposed with gridded structure.

The front side of the housing 1 is square shaped.

It further comprises an infrared receiver 63, the output of the infrared receiver 63 is connected to the controller 5.

It further comprises a Bluetooth speaker box 64, the Bluetooth speaker box 64 is connected to the power device; the Bluetooth speaker box 64 is powered by the AC adapter. The Bluetooth speaker box is a speaker device with built-in Bluetooth chip that it is Bluetooth connected replacing the traditional wire connected, it can be connected to a Bluetooth player like handphone, tablet computer or notebook, thus achieving convenient usage.

The energy-saving lighting device with multimedia and high efficiency filtering and purifying functions of the present invention is applying HEPA purifying technology to the existing lighting device to filter the dust, pollen and smog of the air; it also has Bluetooth music playing function, so that it can be conveniently controlled in the handphone 72, computer and other devices with Bluetooth; and with the infraction remote controller 71, people can remote control the brightness and color of the lighting device, it is very convenient. The light device is a multimedia lighting device combining lighting, purifying, music playing, light adjusting functions. Starting the power, under the work of the centrifugal fan 2, air with inhalable particles enters through the air inlet of the housing, after purified by the HEPA filter 3, the air is hurled out of the blade of the centrifugal fan, when passing through the rear side of the hot body, the LED light source panel 4, the air takes the heat of the hot body out. It not only purifies air, but also cooling the lighting device, thus extending the service life of the LED efficiently. And with the infraction remote controlling function, it can control the purifying speed, brightness of the lighting device. When the Bluetooth speaker box 64 receives the handphone's Bluetooth wireless signal, it can select and control the music and the volume.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. An energy-saving lighting device with multimedia and high efficiency filtering and purifying functions, wherein comprising a housing, a centrifugal fan, an HEPA filter, an LED light source panel, a controller and a power device; the LED light source panel is attached to the front side of the housing; the housing is disposed with an air inlet and an air outlet, an airway is disposed between the air inlet and the air outlet and the air way goes through the rear side of the LED light source panel, the centrifugal fan is disposed in the airway; the HEPA filter is assembled in the airway and is placed between the air inlet of the housing and the centrifugal fan; the output of the controller is respectively connected to the centrifugal fan and the LED light source panel; the power device is connected to the controller.

2. The energy-saving lighting device with multimedia and high efficiency filtering and purifying functions according to claim 1, wherein the air inlet of the housing is disposed at the center of the front side of the housing, the LED light source panel encircles at the periphery of the air inlet; the centrifugal fan is assembled at the center of the inner side of the rear side of the housing, the inlet of the centrifugal fan is opposite to the air inlet of the housing, the HEPA filter is assembled between the air inlet of the housing and the inlet of the centrifugal fan.

3. The energy-saving lighting device with multimedia and high efficiency filtering and purifying functions according to claim 2, wherein the air outlet of the housing is disposed at the periphery of the side surface of the housing and is connected to the outlet of the centrifugal fan, so that the airway goes through the rear side of the LED light source panel.

4. The energy-saving lighting device with multimedia and high efficiency filtering and purifying functions according to claim 1, wherein the side surface of the housing is inclinedly disposed, the size of the periphery of the front side is smaller than that of the rear side.

5. The energy-saving lighting device with multimedia and high efficiency filtering and purifying functions according to claim 1, wherein the rear side of the housing is disposed with a protruding backwardly, the centrifugal fan is accommodated in the inner side of the protruding.

6. The energy-saving lighting device with multimedia and high efficiency filtering and purifying functions according to claim 1, wherein the air inlet of the housing is disposed with a cover plate, the cover plate is gridded.

7. The energy-saving lighting device with multimedia and high efficiency filtering and purifying functions according to claim 1, wherein the air outlet of the housing is disposed with gridded structure.

8. The energy-saving lighting device with multimedia and high efficiency filtering and purifying functions according to claim 1, wherein the front side of the housing is square shaped.

9. The energy-saving lighting device with multimedia and high efficiency filtering and purifying functions according to claim 1, wherein further comprising an infrared receiver, the output of the infrared receiver is connected to the controller.

10. The energy-saving lighting device with multimedia and high efficiency filtering and purifying functions according to claim 9, wherein further comprising a Bluetooth speaker box, the Bluetooth speaker box is connected to the power device.
